(19) United States
(12) Patent Application Publication
(10) Pub. No.: US 2003/0113419 A1
(43) Pub. Date: Jun. 19, 2003

(54) Process to cure and season uncooked sliced beef, pork and poultry

(76) Inventor: F. Peter Paddock, Rutland, MA (US)

Correspondence Address: James F. Baird, Esquire, 33 East Main Street, P.O. Box 574, West Brookfield, MA, 01585-0574, US

(21) Appl. No.: 10/016,394

(22) Filed: Dec. 17, 2001

(51) Int. Cl. A23L 1/31

(52) U.S. Cl. 426/281

(57) ABSTRACT

A new and improved process to cure and season uncooked sliced beef, pork and poultry products. The process involves the selection of the desired principal ingredient, being either beef, pork or poultry. The desired principal ingredient is then frozen, tempered to desired temperature below freezing and sliced thin. The sliced principal ingredient is then blended with salt, spice blend, curing agent, sodium erythorbate and water in a blending machine. The blended product is then packaged and stored in a refrigerated cooler allowing the curing agent and spices to cure and season the blended product, forming the final product. The final product is then kept refrigerated for immediate use, or frozen for shipment and future use. The final product must be cooked by the consumer prior to eating.

### BACKGROUND OF THE INVENTION

Over the years the preparation of food has relied on various methods to keep the particular food item edible if not eaten fresh or soon after cooking. Some of the methods used to preserve and prolong the usability of foods have included freezing, drying, smoking and curing. For some foods the taste and appeal or appearance of the particular food has been improved and enhanced as a result of the process. This is particularly true of Pastrami. The curing and seasoning process brings out a flavor that is not present in the unprocessed beef In the past in order to prepare Pastrami it was necessary to cook the main ingredient, beef, as a part of the process. No matter what sequence was used to cook, cure or season the beef, to become the final product, the cooking time comprised a major portion of the time. The cooking time prolonged the total time required. As time is money the cooking time increased the cost of producing the Pastrami. This is also true for other beef products. The same problem applies to the preparation of pork and poultry. There is in any event still a requirement to cook the Pastrami a second time prior to consumption.

The present invention is a new and improved process to prepare Pastrami without cooking the beef during the initial processing. The result is a much reduced time for preparation thereby reducing the cost of preparation. This process is equally applicable to beef, in general, pork or poultry.

An object of the invention is to develop a process for the preparation of Pastrami that does not involve cooking the pastrami during the initial processing.

Another object of the invention is to develop a process to cure and preserve beef that does not involve cooking the beef during the initial processing.

A further object of the invention is to develop a process to cure and preserve pork that does not involve cooking the pork during the initial processing.

A still further object of the invention is to develop a process to cure and preserve poultry that does not involve cooking the poultry during the initial processing.

With these and other objects in view, as will be apparent to those skilled in the art, the invention resides in the process set forth in the specification and covered by the claims appended hereto.

### SUMMARY OF THE INVENTION

The field of my invention is a process for food preparation, in particular a process for preparing beef, pork or poultry in a cured and seasoned form, without the necessity of cooking during the initial processing. I have found the process to be particularly effective in preparing Pastrami.

I discovered a process for preparing beef, pork or poultry that includes curing and seasoning, however, does not require or include cooking during the initial processing.

In general the process includes:

selecting the desired principal ingredient, being uncooked beef pork or poultry;

freezing the desired principal ingredient;

then tempering the temperature of the desired principal ingredient to a desired temperature being in the range 25-29° F. for a predetermined time;

the desired principal ingredient is then sliced to a desired thickness;

the desired principal ingredient is then blended with salt, spice blend, curing agent from the group that includes sodium nitrate, water and sodium erythorbate in a blending machine that is from the group that is USDA approved forming a blended product;

package the blended product in packaging that is from the group that is USDA approved;

store the blended product in a refrigerated cooler for approximately 24 hours allowing the curing agent and spices too cure and season the desired principal ingredient forming the final product; and

the final product is then kept refrigerated for near term consumption. In the event the final product requires long term storage or shipping it is possible to freeze the final product.

The difference between my process and processes used presently, or in the past, is that my process does not include any requirement that the beef, pork or poultry be cooked during the initial processing. As with most beef, pork or poultry products it is necessary that the product be cooked prior to consumption by the consumer. The freezing and tempering steps are necessary in order that the beef, pork or poultry will slice without turning to a soft blob.

My process saves time and therefore money.

While the invention will be discussed in connection with a preferred embodiment, it will be understood that we do not intend to limit the invention to that embodiment. On the contrary we intend to cover all alternatives, modifications and equivalents as may be included within the spirit and scope of the invention as defined by the appended claims.

### BRIEF DESCRIPTION OF THE DRAWINGS

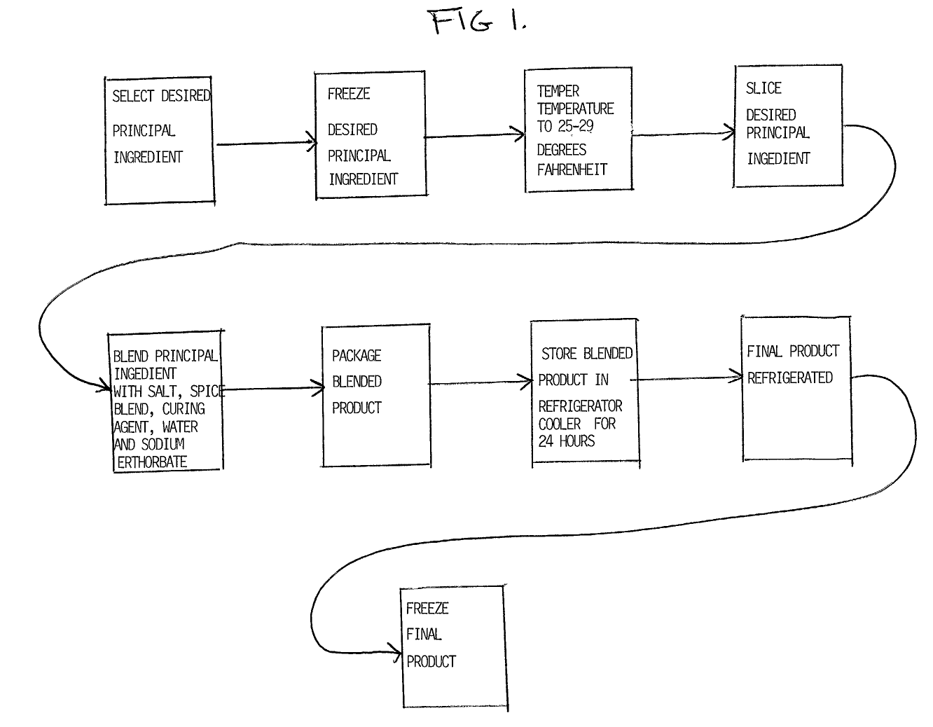

Turning to FIG. 1 there are shown the several steps involved in the process. Step 1 is the selection of the desired principal ingredient. Step 2 is the desired principal ingredient being frozen to a temperature below freezing. Step 3 is the temperature of the desired principal ingredient being tempered, to a temperature that is between 25-29 degrees F. Step 4 is the desired principal ingredient being sliced to a desired thickness. At Step 5 the desired principal ingredient is blended with salt, spice blend, curing agent, water and sodium erythorbate. The curing agent is from the group that includes sodium nitrate. The blending is done in a blending machine that is from the group that is USDA approved. Step 6 is the blended product being packaged. The packaging is from the group that is USDA approved. Step 7 is the blended product being stored in a refrigerator for approximately 24 hours. Step 8 is the final product being refrigerated for near term consumption. An addition Step 9 is the final product being frozen for storage or shipment.

### DESCRIPTION OF THE PREFERRED EMBODIMENT

Referring to FIG. 1 a block diagram is shown illustrating the process.

Step 1 is the selection of the desired principal ingredient. Step 2 shows the desired principal ingredient being frozen to a temperature below freezing. Step 3 shows the temperature of the desired principal ingredient being tempered, to a temperature that is between 25-29 degrees F. It is desired that the principal ingredient be kept frozen in order that the slicing process results in slices and not a soft mass as would result if the principal ingredient is thawing or crumbling pieces if the principal ingredient is too hard. Step 4 shows the desired principal ingredient being sliced to a desired thickness. At Step 5 the desired principal ingredient is blended with salt, spice blend, curing agent, water and sodium erythorbate. The curing agent is from the group that includes sodium nitrate. The blending is done in a blending machine that is from the group that is USDA approved. Step 6 shows the blended product being packaged. The packaging is from the group that is USDA approved. Step 7 has the blended product stored in a refrigerator for 24 hours. During this storage period the curing agent and spices cure and season the blended product forming the final product. Step 8 shows the final product being refrigerated for near term consumption. An addition Step 9 shows the final product being frozen for storage or shipment.

From the foregoing description it will be apparent that modifications can be made to the process without departing from the teaching of the present invention. Accordingly, it is distinctly understood that the invention is not limited to the preferred embodiment but may be embodied and practiced within the scope of the following claims.

I claim the following:

1. Process to cure and season uncooked sliced beef with uncooked beef being the principal ingredient comprising the steps of:
a) select the desired principal ingredient, being uncooked beef;
b) freeze the desired principal ingredient;
c) the temperature of the desired principal ingredient is then tempered to a desired temperature, being in the range 25-29° F., for a predetermined time;
d) the desired principal ingredient is then sliced to a desired thickness;
e) the desired principal ingredient is then blended with salt, spice blend, curing agent from the group that includes sodium nitrate, water and sodium erythorbate in a blending machine, that is from the group that is USDA approved, forming a blended product;
f) package the blended product in packaging, that is from the group that is USDA approved;
g) store the blended product in a refrigerated cooler for 24 hours allowing the curing agent and spices too cure and season the desired principal ingredient forming the final product; and
h) the final product is then kept refrigerated for near term consumption.

2. Process to cure and season uncooked sliced beef with uncooked beef being the principal ingredient as recited in claim 1 including the additional step of:
i) freeze the final product for shipment and future consumption.

3. Process to cure and season uncooked sliced pork with uncooked pork being the principal ingredient comprising the steps of:
a) select the desired principal ingredient, being uncooked pork;
b) freeze the desired principal ingredient;
c) the temperature of the desired principal ingredient is then tempered to a desired temperature, in the range 25-29° F., for a predetermined time;
d) the desired principal ingredient is then sliced to a desired thickness;
e) the desired principal ingredient is then blended with salt, spice blend, curing agent from the group that includes sodium nitrate, water and sodium erythorbate in a blending machine, that is from the group that is USDA approved, forming a blended product;
f) package the blended product in packaging, that is from the group that is USDA approved;
g) store the blended product in a refrigerated cooler for 24 hours allowing the curing agent and spices too cure and season the desired principal ingredient forming the final product; and
h) the final product is then kept refrigerated for near term consumption.

4. Process to cure and season uncooked sliced pork with uncooked pork being the principal ingredient as recited in claim 3 including the additional step of:
i) freeze the final product for shipment and future consumption.

5. Process to cure and season uncooked sliced poultry with uncooked poultry being the principal ingredient comprising the steps of:
a) select the desired principal ingredient, being uncooked poultry;
b) freeze the desired principal ingredient;
c) the temperature of the desired principal ingredient is then tempered to a desired temperature, in the range 25-29° F., for a predetermined time;
d) the desired principal ingredient is then sliced to a desired thickness;
e) the desired principal ingredient is then blended with salt, spice blend, curing agent from the group that includes sodium nitrate, water and sodium erythorbate in a blending machine, that is from the group that is USDA approved, forming a blended product;
f) package the blended product in packaging, that is from the group that is USDA approved;
g) store the blended product in a refrigerated cooler for 24 hours allowing the curing agent and spices too cure and season the desired principal ingredient forming the final product; and
h) the final product is then kept refrigerated for near term consumption.

6. Process to cure and season uncooked sliced poultry with uncooked poultry being the principal ingredient as recited in claim 5 including the additional step of:
i) freeze the final product for shipment and future consumption.
